(19) United States
(12) Patent Application Publication
(10) Pub. No.: US 2014/0088904 A1
(43) Pub. Date: Mar. 27, 2014

(54) MOTION DETECTION AUTOTUNING

(71) Applicant: REDWOOD SYSTEMS, INC., Fremont, CA (US)

(72) Inventor: Mark Covaro, Sonoma, CA (US)

(73) Assignee: REDWOOD SYSTEMS, INC., Fremont, CA (US)

(21) Appl. No.: 13/629,111

(22) Filed: Sep. 27, 2012

(51) Int. Cl. G01P 21/00; F24F 11/00; G06F 19/00

(52) U.S. Cl. 702/94; 73/1.79; 165/237

(57) ABSTRACT

A system may be provided for limiting false detections of occupancy caused by air flow. The system may include control unit and sensors that detect motion in one or more areas, where the control unit and the sensors are connected by a network. The control unit may determine that the area or areas are unoccupied, and autotune parameters of the sensors so that the sensors indicate that the area or areas are unoccupied.

### BACKGROUND

1. Technical Field

This application relates to sensors and, in particular, to motion detectors.

2. Related Art

Occupancy detectors may detect whether an area is occupied. Occupancy detectors may function by detecting motion and equating the detection of motion to the detection of an occupant.

### SUMMARY

A control unit may be provided for limiting false detections of occupancy caused by air flow. The control unit may include a communications circuit that communicates over a network with sensors that detect motion in an area. The control unit may also include an occupancy module that determines the area is unoccupied. The control unit may further include an autotune module that determines, for each of the sensors on the network, a tuned value set from multiple value sets such that a respective one of the sensors transmits an indication over the network to the communications circuit that the area is unoccupied when parameters of the respective one of the sensors are set to the tuned value set, and the area is determined by the occupancy module to be unoccupied.

A sensor gateway may be provided for limiting false detections of occupancy caused by air flow. The sensor gateway may include a communications circuit configured to communicate over a network with a control unit. The sensor gateway may also include a memory and processor, where the processor receives data over the network from the control unit via the communications circuit, the data indicating an area is unoccupied. The processor may process a signal from a sensor positioned to detect movement in the area. The memory may include an autotune module that iterates over a list of multiple values for a parameter of the sensor, and causes the processor to set the parameter of the sensor to each of the values. The autotune module may determine, for each of the values, whether the signal from the sensor indicates the area is unoccupied. The autotune module may select a tuned value from the values such that the signal from the sensor indicates the area is unoccupied when the parameter of the sensor is set to the tuned value and the data from the control unit indicates the area is unoccupied.

A method may be provided to limit false detections of occupancy caused by air flow. A determination may be made at a control unit that an area monitored by a sensor is unoccupied, where the control unit includes a communications circuit that communicates with the sensor over a network. A sensor signal may be received at the control unit from the sensor over the network, where the sensor signal indicates whether the sensor detects an occupant in the area. Multiple parameters of the sensor may be set to multiple value sets by transmitting parameter commands via the communications circuit over the network to the sensor, where each of the value sets comprises a respective set of values for the parameters of the sensor. A determination may be made by the control unit, for each of the value sets, whether the sensor signal indicates that the area is occupied when the parameters of the sensor are set to the respective set of values and when the area is determined by the control unit to be unoccupied. A tuned value set may be selected with the control unit from the value sets such that the sensor signal indicates the area is unoccupied when the parameters of the sensor are set to the tuned value set and the area is unoccupied according to the indication received from the control unit.

Further objects and advantages of the present disclosure will be apparent from the following description, reference being made to the accompanying drawings.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a system to limit false detections of occupancy caused by air flow;

FIG. 2 illustrates an example flow diagram of logic of a system where a tuned value set is dynamically selected;

FIG. 3 illustrates an example of a system in which a sensor gateway tunes sensors at the direction of a control unit; and

FIG. 4 illustrates an example flow diagram of the logic of a system to limit false detections of occupancy caused by air flow.

### DETAILED DESCRIPTION

In one example, a system may be provided for limiting false detections of occupancy caused by air flow. The system may include a control unit and sensors that detect motion in one or more areas, where the control unit and the sensors are connected by a network. The control unit may include a communications circuit that communicates over a network with the sensors. Each of the sensors may include or be colocated with a corresponding sensor gateway that performs the communication on behalf of each sensor. The control unit may include an occupancy module that determines that the area monitored by the sensors is unoccupied. For example, the control unit may receive user input indicating that the area is unoccupied.

The sensors may have been configured with a predetermined set of values for parameters of the sensor. The predetermined set of values may have been provided by a supplier of the sensors as being appropriate for conditions in which the sensors were installed. Despite applying the predetermined set of values for the parameters, the sensors may still improperly detect motion indicating that the area is occupied because of airflow passing in front of the sensors triggering the detection of motion. For example, strong currents of air may circulate in a data center when air conditioning units generate cool air to counteract heat radiating from electronic equipment. An inexpensive motion detector, such as an analog pyroelectric infrared sensor (PIR) or a digital pyroelectric infrared sensor (DPIR), may mistake the movement of the hot and/or cold air for movement of a person.

The sensor gateway may include a component that sets the parameters of the sensors to values. The control unit may include an autotune module that determines, for each of the sensors on the network, a tuned value set from multiple value sets such that a respective one of the sensors transmits an indication over the network to the control unit that the area is unoccupied when the parameters of the respective one of the sensors are set to the tuned value set, and the area is determined to be unoccupied by the occupancy module. In addition, the autotune module may determine the tuned value set for a corresponding environmental condition detected in the area, such as a corresponding temperature and/or a corresponding time of day. The control unit may subsequently set the parameters of the sensors to the tuned value set whenever the corresponding environmental condition is detected.

By dynamically determining the tuned value set, the parameters of the sensors may more accurately determine whether the area is occupied when environmental conditions in the area change. In addition, the sensors may be tuned in place. Because the sensors may be hard to reach, any difficulty in physically accessing the sensors may be avoided. Inexpensive sensors may be made accurate enough to satisfy business requirements. Redundant sensors used to verify that other sensors properly detect occupant motion may be unnecessary in some examples. A large network of the sensors may be tuned quickly and without any substantial human effort.

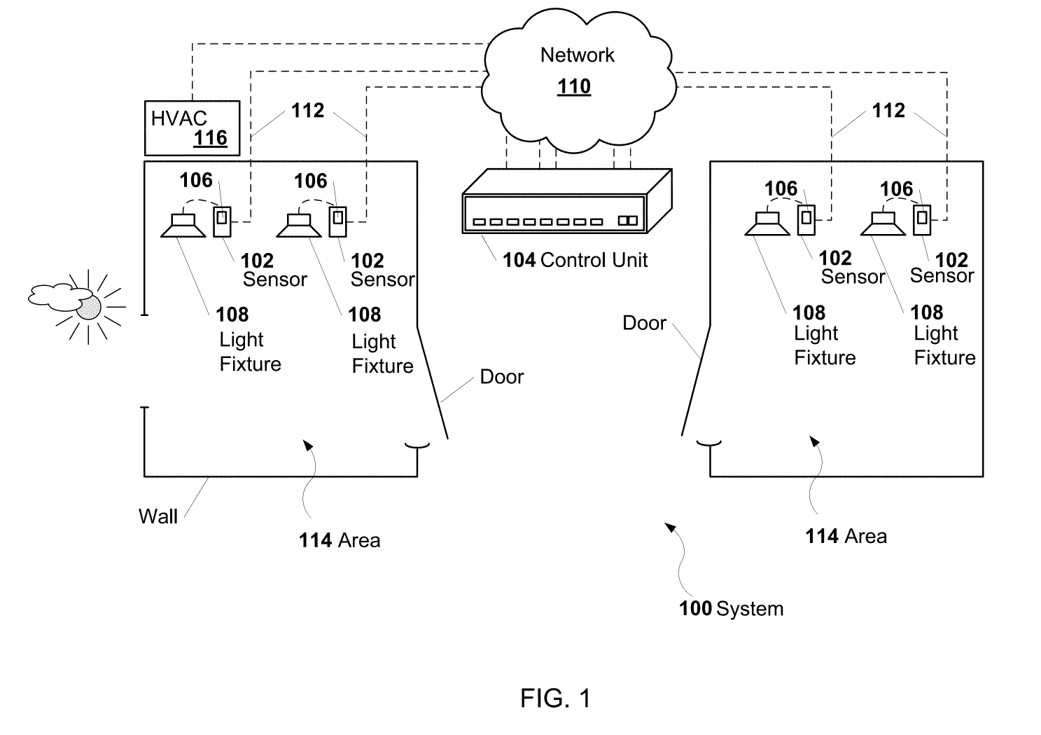

FIG. 1 illustrates an example of a system 100 to limit false detections of occupancy caused by air flow. The system 100 may include sensors 102 and a control unit 104. The system 100 may include more, fewer, or different elements. For example, the system 100 may additionally include sensor gateways 106 that are included in the sensors 102 and/or are electrically coupled to the sensors 102. In another example, the system 100 may include light fixtures 108. The control unit 104 may communicate with the sensors 102 over a network 110.

The sensors 102 may be any type of motion sensors. Examples of the sensors 102 may include a digital pyroelectric infrared sensor (DPIR), an ultrasonic sensor, an xband (microwave Doppler) sensor, and any other type of sensor that detects motion. Each of the sensors 102 may include a sensing element that generates a sensor element signal. Each of the sensors 102 may include a detection component that converts the sensor element signal into a sensor signal. The sensor signal may include a motion signal that indicates whether motion is detected by the sensor 102. Alternatively or in addition, the sensor signal may include an occupancy signal that indicates whether an area 114 is occupied. The sensors 102 may transmit the sensor signal over the network 110 to the control unit 104. The sensors 102 may be coupled to a ceiling, a floor, a wall, or some other portion of a building or physical structure from which the sensors 102 may detect motion in the area 114. The sensors 102 on the network 110 may all be of a common type, such as a DPIR. Alternatively, the type of the sensors 102 on the network 110 may vary throughout the network 110.

Each of the sensors 102 may have parameters that may be dynamically set to values. The parameters of the sensors 102 may control various aspects of motion detection. For example, the parameters may include a sensitivity parameter that controls gain of the sensor signal. Alternatively or in addition, the parameters may include an edge rate parameter. The edge rate parameter may direct the sensor 102 to filter for an edge rate of a motion signal. The edge rate may be an inverse frequency of change in the motion signal over a predetermined duration. Hot air passing by the sensor 102 may cause the motion signal to have a lower frequency change (slower edge rate) than a human or other object may cause the motion signal to have. More generally, the parameters may include a frequency spectral content parameter. The frequency spectral content parameter may direct the sensor 102 to filter based on frequency information. For example, the frequency spectral content parameter may direct the sensor 102 to filter out and/or focus in on a pattern in the frequency domain. Alternatively or in addition, the parameters may include a filter parameter that causes the sensor 102 to ignore a determined frequency, frequency range, or a determined duration. The sensors 102 may have any number and/or type of parameters. Each of the sensors 102 may or may not have the same parameters as the other sensors 102.

The control unit 104 may be any device or combination of devices that communicates with sensors 102 over the network 110. In one example, the control unit 104 may be a power device that provides power to the sensors 102 and/or the light fixtures 108. For example, the control unit 104 may include a power converter that provides power over wiring 112. The power converter may include, for example, an AC/DC (Alternating Current/Direct Current) converter and/or a DC/DC converter. The wiring 112 may be 12 AWG (American Wire Gauge) building wiring, 18 AWG wiring, Category 5 (Cat 5), Category 5e (Cat 5e), Category 6 (Cat 6), or any other type of wiring. In a second example, the control unit 104 may not power the sensors 102 and/or the light fixtures 108.

The network 110 may be any set of channels over which a collection of computers, processors, and/or other hardware components are interconnected and share information. The network 110 may include a computer network, a local area network (LAN), a wireless local area network (WLAN), a WI-FI® (a registered trademark of Wireless Ethernet Compatibility Alliance, Inc. of Austin, Tex.) network, a personal area network (PAN), a wide area network (WAN), the Internet, an Internet Protocol (IP) network, a mesh network, a peer-to-peer network, a proprietary network, a packet based network, and/or any other communications network, or any combination thereof. The network 110 may include the wiring 112. For example, the control unit 104 and the sensors 102, which may be physically remote from each other, may communicate over the wiring 112 or over a wireless channel using a proprietary protocol and/or a standard protocol. In one example, the control unit 104 may power the sensors 102 and/or the light fixtures 108 with the wiring 112 over which the control unit 104 and the sensors 102 communicate.

Each light fixture 108 or luminaire may be any electrical device or combination of devices that creates artificial light from electricity. The light fixture 108 may distribute, filter or transform the light from one or more lamps included or installed in the light fixture 108. Alternatively or in addition, the light fixture 108 may include one or more lamps. The lamps may include incandescent bulbs, LED lights, fluorescent tubes, any other device now known or later discovered that generates artificial light, or any combination thereof. The light fixture 108 may be free standing or coupled to a ceiling, a floor, a wall, or some other portion of a building or physical structure from which the light fixture 108 may emit light. Examples of the light fixture 108 include a compact fluorescent light, a task/wall bracket fixture, a linear fluorescent high-bay, a spot light, a recessed louver light, a desk lamp, a troffer, or any other device that includes and/or receives one or more lamps.

During operation of the system 100 for limiting false detections of occupancy caused by air flow, the control unit 104 may determine when the area 114 or areas monitored by the sensors 102 are unoccupied. The control unit 104 may determine that the area 114 is unoccupied using any number of mechanisms. For example, a person may press a button on the control unit 104 indicating that the area 114 is unoccupied. Alternatively or in addition, a person may interact with a program executing on a mobile computing device that causes the mobile computing device to transmit data over the network 110 to the control unit 104 indicating that the area 114 is unoccupied. In yet another example, the control unit 104 may determine that the area 114 is unoccupied if the current time is within a determined timeframe, such as after work hours. In still another example, the control unit 104 may track occupants as the occupants move through the area 114 by receiving staggered motion detection events in the sensor signals. Upon detecting that the occupants have left the area 114 and/or no longer receiving any motion detection events from the sensors 102 in the area 114 over a predetermined period of time, the control unit 104 may determine that the area 114 is unoccupied.

The area 114 may be occupied when one or more occupants are in the area 114. In contrast, the area 114 may be unoccupied when no occupants are in the area 114. The occupants may be people, animals, any other living creature, or any object that moves, such as a mobile robotic device.

When the control unit 104 determines that the area 114 is unoccupied, the control unit 104 may tune the sensors 102 to limit false detections of occupancy caused by air flow or temperature variations. In particular, the central unit 104 may determine, for each of the sensors 102 that monitor the area 114, a tuned value set such that each respective one of the sensors 102 indicates that no motion is detected when the parameters of each respective one of the sensors 102 are set to the tuned value set and the area 114 is unoccupied.

In one example, the control unit 104 may transmit parameter commands, over the network 110 to the sensors 102. The parameter commands may identify values that the parameters of the sensors 102 are to be set to. In response, the sensors 102 may be configured with the values for the parameters identified in the parameter commands transmitted by the control unit 104 over the network 110. The sensors 102 may transmit the sensor signals over the network 110 to the control unit 104. The sensor signals may indicate whether the sensors 102 detected movement and/or occupancy in the area 114 after being configured with the values for the parameters. The parameter commands transmitted by the control unit 104, together with the sensor signals transmitted by the sensors 102, may form a closed feedback loop between the control unit 104 and the sensors 102.

The closed feedback loop enables the control unit 104 to tune the sensors 102 such that the frequency the sensor signals indicate motion and/or occupancy is detected is limited and/or eliminated when the area 114 is determined to be unoccupied. As a result, the parameters of the sensors 102 may be adjusted to limit or eliminate the effect of air flow that may be present in the area 114. In particular, the parameters of the sensors 102 may be adjusted specifically for each of the sensors 102 to compensate for the air flow that may be present around the specific sensor 102. For example, the sensors 102 may be installed in a data center, which may have a large amount of air moving at different speeds and at different temperatures within the data center. Accordingly, the air adjacent a first one of the sensors 102 may be moving at different speed and at different temperature than the air near adjacent a second one of the sensors 102. Without the tuning, the sensors 102 may confuse the moving air for an occupant moving in the area 114. The closed feedback loop enables the control unit 104 to individually tune each of the sensors 102 for environmental conditions specific to the portion of the area 114 adjacent to each respective one of the sensors 102.

As described in detail below, the control unit 104 may tune the sensors 102 by applying any number of sensor tuning algorithms. In one example, a person operating the system 100 (an operator), the control unit 104, or some other device may cause a Heating, Ventilation, and Air Conditioning (HVAC) system 116 and/or a lighting system to bring the area 114 to a predetermined condition. The predetermined condition may be a normal operating condition of the area 114 or any other target environmental condition of the area 114. The target condition may include a target temperature, an indication that one or more blowers in the HVAC system 116 are on, a lighting condition, and/or any other adjustable or measureable characteristic of the area 114. Alternatively, the control unit 104 may proceed with the tuning in a current condition of the area 114 instead of bringing the area 114 to the target condition.

While the operator keeps occupants from entering the area 114, or while the area 114 otherwise remains unoccupied, the control unit 104 may proceed with tuning the sensors 102. The control unit 104 may set the parameters of the sensors 102 to multiple value sets over time. Each of the value sets may include a respective set of values for the parameters of the sensors 102. The control unit 104 may determine, for each of the value sets, whether the sensor signal indicates motion is detected by a respective one of the sensor 102 when the parameters (or parameter) of the respective sensor 102 are set to the respective set of values.

Table 1 below illustrates an example of data that the control unit 104 gathers, where the value sets are for two parameters: parameter A and parameter B. Parameter A may be set to any number in a range from 1 to 3. Parameter B may be set to any number in a range from 1 to 10. According to Table 1, when parameter A is set to 1, then no motion is detected by the sensor 102 when parameter B is set to any number in a range from 5-9. When parameter A is set to 2, then no motion is detected by the sensor 102 when parameter B is set to any number in a range from 4-8. When parameter A is set to 3, then no motion is detected by the sensor 102 when parameter B was set to any number in a range from 5-9. In other examples, additional and/or different parameters than the parameters illustrated in Table 1 may be adjusted. Valid ranges and/or data types of the parameters may be different than illustrated in Table 1.

TABLE 1

Value Sets

| Parameter A | Parameter B | Motion Detected |
|---|---|---|
| 1 | 1-4 | Yes |
| 1 | 5-9 | No |
| 1 | 10 | Yes |
| 2 | 1-3 | Yes |
| 2 | 4-8 | No |
| 2 | 9-10 | Yes |
| 3 | 1-4 | Yes |
| 3 | 5-9 | No |
| 3 | 10 | Yes |

The control unit 104 may use nested loops when generating the value sets. The number of nested loops may depend on the number of the parameters that are to be adjusted on the respective sensor 102. For example, the control unit 104 may loop through values for parameter A. For each value of parameter A, the control unit 104 may perform a nested loop through the range of possible values for parameter B.

The control unit 104 may start with the parameter that is the most sensitive parameter in the outer-most loop, and use progressively less sensitive parameters for each successive inner loop, ending with the least sensitive parameter in the inner-most loop. The less sensitive the parameter, the less effect on whether the sensor 102 detects motion. For example, sensitivity and range parameters may have more effect on detecting motion than other types of parameters.

The value sets for the parameters, together with the data indicating whether the sensor 102 detects motions when the parameters are set to a respective one of the value sets, may form a matrix, such as Table 1. The matrix may provide the control unit 104 with information from which the control unit 104 may determine the tuned value set for the sensor 102.

The control unit 104 may select a value set from among the value sets in the matrix for a respective one of the sensors 102 such that no motion was detected by the respective sensor 102 when the parameter or parameters of the respective sensor 102 were set to the selected value set. The respective sensor 102 may be considered tuned when the parameter or parameters of the sensor 102 are set to the selected value set. Accordingly, the selected value set may be referred to as the tuned value set. When tuned, each sensor 102 may have a different set of values for the parameters than the other sensors 102. Alternatively, when tuned, the sensors 102 may share a common set of values for the parameters.

The control unit 104 may select the tuned value set as a set of values within a determined range of values that caused the sensor 102 not to detect motion. The determined range of values for one of the parameters may be a range of values for the parameter that cause the sensor 102 not to detect motion. In the example illustrated in Table 1, the determined range of values for parameter B may be 5-8. Regardless of the value of parameter A, whenever parameter B was set to a value within the determined range of 5-8, the sensor 102 did not detect motion. The first value and/or the last value in the determined range may be a transition value because a value just before the first value of the determined range, and/or a value just after the last value of the determined range, may cause the sensor 102 to detect motion.

The control unit 104 may select the tuned value for the parameter as the value in the determined range that is within a predetermined distance of one or both of the transition values. The predetermined distance may be sized so that the tuned value is not one of the transition values. In the example illustrated in Table 1, the value of 8 may be a transition value for parameter B because the value of 9 causes the sensor 102 to detect motion, whereas the value of 8 causes the sensor 102 not to detect motion, when parameter A is set to 2. If the predetermined distance is one, for example, then the control unit 104 may select the value 7 for parameter B (7 is one away from the transition value of 8).

Alternatively or in addition, the control unit 104 may select the tuned value as the value in the middle of the determined range. For example, a value in the middle of the determined range of 5-8 may be 6 or 7. Accordingly, the control unit 104 may select the tuned value for parameter B to be 6 or 7.

Alternatively or in addition, the control unit 104 may select the tuned value from the determined range based on knowledge of the operation of the sensor 102. For example, the sensor 102 may be known to be effective at detecting motion when the value of parameter B is in an effective range, such as a range between 4 and 6. The control unit 104 may select the tuned value for parameter B as a value that is in both the effective range and the determined range.

The control unit 104 may similarly determine each of the tuned values in the tuned value set. In the example illustrated in Table 1, all possible values of parameter A caused the sensor 102 not to detect motion when parameter B was set to any value in the determined range of 5-8 for parameter B. Accordingly, the determined range for parameter A may be 1-3. The control unit 104 may select the tuned value for parameter A to be the middle of the determined range for parameter A, a value within the determined range that is within a predetermined distance of one or both of the ends of the determined range, or any other value in the determined range for parameter A.

The control unit 104 may select the value set that caused the sensor 102 not to detect motion by analyzing the completed matrix of the value sets for the parameters and the data indicating whether the sensor 102 detects motions when the parameters are set to a respective one of the value sets. Alternatively or in addition, the control unit 104 may select the value set dynamically as the first value set that causes the sensor 102 not to detect motion and/or that meets other criterion.

In some examples, the control unit 104 may determine the tuned value set from user input instead of determining the tuned value set without user input. A user may manually direct the control unit 104 to select a particular value set as the tuned value set instead of, or in addition to the control unit 104 selecting the value set. The user may view the completed matrix of the value sets for the parameters in a graphical user interface (GUI). The user may select one of the values sets as the tuned value set through the GUI. Alternatively or in addition, the user may manually enter the value set through the GUI. The user may set the value set of each of the sensors 102 individually or in groups. Accordingly, the user may tune the sensors 102 on the network 104 with a press of a button in the GUI regardless of the number of the sensors 102 installed.

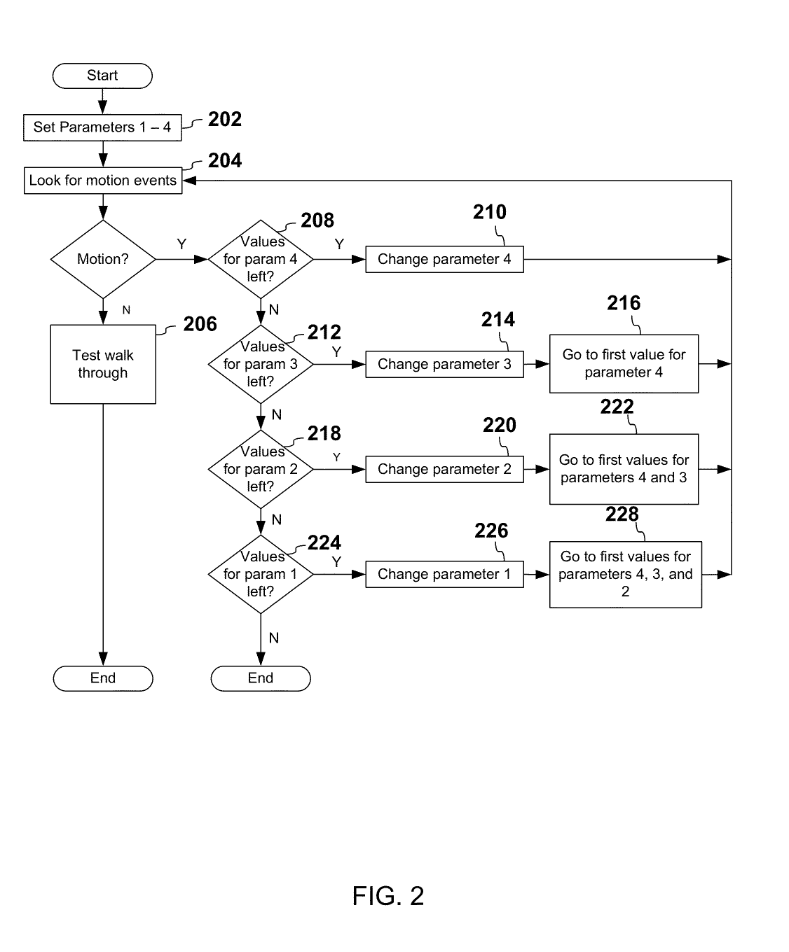

FIG. 2 illustrates an example flow diagram of the logic of the system 100 where the tuned value set is dynamically selected as the first value set encountered that causes the sensor 102 not to detect motion. The logic may include additional, different, or fewer operations. The operations may be executed in a different order than illustrated in FIG. 2.

In the example illustrated in FIG. 2, four parameters are adjusted: parameter 1, parameter 2, parameter 3, and parameter 4. As described in more detail below, each of the parameters may be set to any value in a corresponding list of values during the adjustment of the parameters. The corresponding list of values may be ordered. The values in the list of values may be arranged sequentially or in any other order.

The logic may begin with an operation in which a value set for parameters 1-4 of the sensor 102 is determined to be an initial value set (202). The initial value set may include the first possible value of each of the parameters. Alternatively, the initial value set may include a different set of predetermined values for the parameters, such as the tuned values set determined in a previous tuning of the sensor 102.

The initial value set may be determined in any number of ways. For example, the initial value set may be retrieved from a heuristics database that is populated with experience-based data. The heuristics database may be populated on a per site basis. For example, the control unit 104 may store the tuned value set obtained in previous tunings of the sensor 102 and/or sensors 102 installed in the site. Alternatively or in addition, the control unit 104 may store the tuned value set obtained in previous tunings of sensors installed at sites having characteristics similar to the installed site. For example, the other sites may be data centers, data centers run by a particular company, restaurants, shopping malls, or any other industry or facility type that matches the installed site. The data stored in the heuristics database may be collected from control units installed throughout the world along with identifying information that identifies characteristics of installed sites, such as industry or facility type. The data may be collected over the network 110, which may include the Internet, and warehoused in a central database.

In other examples, the initial value set may be determined based on an understanding of sensor behavior. If only a range of values for one of the parameters is understood to be effective at detecting occupancy, then the initial value may be chosen to be at the start of the range of values. For example, the range of values for the edge rate may be limited to a subset of possible values for the edge rate when detecting an occupant. In another example, a first range of values may be applicable to detecting an occupant who is 10 feet away from the sensor 102, and a second range of values may be applicable to detecting an occupant who is 20 feet away from the sensor 102. The initial value may be selected based on the distance the sensor 102 may be from a possible occupant in the area 114.

With the value set of the parameters determined, the parameters may be set to the value set and a determination made whether the sensor 102 detects motion (204). If the sensor 102 does not detect motion, then the logic may end, for example, with an operation in which a test is performed to determine whether the sensor 102 as tuned detects motion when an occupant moves in the area 114 (206). The values of the parameters when the sensor 102 does not detect motion may be considered the tuned or selected value set.

Alternatively, if the sensor 102 does detect motion, then the logic may proceed to an operation in which a determination is made whether all of the values in the list of values for parameter 4 have been tried (208). If not all of the values in the list of values for parameter 4 have been tried, then the value of parameter 4 in the value set may be adjusted to a next value in the list of values for parameter 4 (210). The logic may proceed back to the operation in which the parameters are set to the value set and a determination is made whether the sensor 102 detects motion (204).

On the other hand, if all of the values in the list of values for parameter 4 have been tried, then the logic may proceed to an operation in which a determination is made whether all of the values in the list of values for parameter 3 have been tried (212). If not all of the values in the list of values for parameter 3 have been tried, then the value of parameter 3 in the value set may be adjusted to a next value in the list of values for parameter 3 (214). In addition to adjusting the value of parameter 3, the value of parameter 4 in the value set may be reset to the first value in the list of values for parameter 4 (216). The logic may proceed back to the operation in which the parameters are set to the value set and a determination is made whether the sensor 102 detects motion (204).

Alternatively, if all of the values in the list of values for parameter 3 have been tried, then the logic may proceed to an operation in which a determination is made whether all of the values in the list of values for parameter 2 have been tried (218). If not all of the values in the list of values for parameter 2 have been tried, then the value of parameter 2 in the value set may be adjusted to a next value in the list of values for parameter 2 (220). In addition to adjusting the value of parameter 2, the values of parameters 3 and 4 in the value set may be reset to the first value in the list of values for parameters 3 and 4, respectively (222). The logic may proceed back to the operation in which the parameters are set to the value set and a determination is made whether the sensor 102 detects motion (204).

On the other hand, if all of the values in the list of values for parameter 2 have been tried, then the logic may proceed to an operation in which a determination is made whether all of the values in the list of values for parameter 1 have been tried (224). If not all of the values in the list of values for parameter 1 have been tried, then the value of parameter 1 in the value set may be adjusted to a next value in the list of values for parameter 1 (226). In addition to adjusting the value of parameter 1, the values of parameters 2, 3 and 4 in the value set may be reset to the first value in the list of values for parameters 2, 3, and 4, respectively (228). The logic may proceed back to the operation in which the parameters are set to the value set and a determination is made whether the sensor 102 detects motion (204).

Alternatively, if all of the values in the list of values for parameter 1 have been tried, then the logic may end by, for example, determining that the sensor 102 may not be tunable under the current conditions of the area 114.

In some examples, the control unit 104 may not adjust the values for each of the parameters in a linear ascending or descending order. Instead, the control unit 104 may adjust the values of each of the parameters in an order that is based on how the sensor 102 responds to the values of the parameters. For example, the values for parameter 4 in FIG. 2 may range from zero to 15. The control unit 104 may adjust the value for parameter 4 from zero to four with a fixed value for parameters 1-3, and then start adjusting the value for parameter 3 if no value set resulted in a failure to detection motion. Then, after the control unit 104 cycles through the list of values for parameter 3, the control unit 104 may adjust the value for parameter 4 from four to 15.

In one example, the sensor 102 may have four parameters: sensitivity, range, extended sensitivity, and frequency response. The value of the sensitivity parameter may range from 0-255, and may be stored in a one byte wide register of the sensor 102. The value of the range parameter may range from 0-7, and may be stored in a three bit register of the sensor 102. The value of the extended sensitivity parameter may range from 0-3, and may be stored in a two bit register of the sensor 102. The value of the frequency response parameter may range from 0-15, and may be stored in a four bit register of the sensor 102. The most useful part of the range of values for the sensitivity parameter may be the values from 8 to 50. Once the value of the sensitivity parameter is higher than a value in an upper range of 16 to 20, the sensor 102 may no longer effectively detect motion under any practical circumstances. Accordingly, the control unit 104 may initially set the value of the sensitivity parameter by iterating over a range of values from 8 to 16. Instead of continuing to value 16, the control unit 104 may iterate over values for other parameters before setting the sensitivity parameter to a value higher than 16. The most useful values for the range parameter may be from 1 to 7. The range parameter may rarely be set to zero. The extended sensitivity parameter may rarely be set to 3, but the other possible values for the extended sensitivity parameter may be commonly used. The frequency response parameter may be set to any value in the complete range of possible values for the frequency response parameter. Other examples may include additional, fewer, or different parameters. The possible values and effective ranges in other examples may vary from example to example.

After tuning the sensor 102 and/or the sensors 102 that monitor the area 114, the system 100 may be tested. For example, a person may walk through the area 114, while the control unit 104 confirms that each of the tuned sensors 102 detects the person walking through the area 114. The person may walk on a path that passes by each of the tuned sensors 102. In a different example, a robot, a robotic automatic vacuum cleaner, a radio controlled toy, or any other motorized mobile device may move along a path that passes each of the tuned sensors 102. The path may form a predetermined pattern in some examples. If the control unit 104 determines that any of the sensors 102 fails to detect the person and/or motorized mobile device, then the control unit 104 may select an alternate value set for the sensor 102 that failed to detect the person and/or motorized mobile device.

The control unit 104 may tune all of the sensors 102 that monitor the area 114 simultaneously or substantially simultaneously. Alternatively, the control unit 104 may tune the sensors 102 that monitor the area 114 in a staggered pattern, serially, or in any other pattern.

The sensors 102 in the system 100 may monitor multiple areas 114. If the areas 114 are all unoccupied at the same time, then the control unit 104 may tune the sensors 102 simultaneously or substantially simultaneously. Alternatively, the control unit 104 may tune the sensors 102 in groups, where each of the groups corresponds to a respective one of the areas 114 that is monitored by the sensors 102 in a respective one of the groups. For example, if a first area is occupied when a second area is unoccupied, then the control unit 104 may tune the sensors 102 that monitor the second unoccupied area, but delay or skip tuning the sensors 104 that monitor the first occupied area.

If the control unit 104 determines that an occupant enters the area 114 during the tuning of the sensors 102 that monitor the area 114, then the control unit 104 may pause the tuning. The control unit 104 may determine that the area 114 becomes occupied using any number of mechanisms. For example, the control unit 104 may detect motion triggers from multiple adjacent sensors 102 that correlate to a pattern representative of a person walking past multiple sensors. Alternatively or in addition, the control unit 104 may pause the tuning at the direction of an operator of the system 100. When the control unit 104 determines that the area 114 is unoccupied again, then the control unit 104 may continue tuning the sensors 102.

In some embodiments, the system 100 may tune the sensors 102 at different operating conditions of the area 114. In one example, the HVAC 116 may be programmed to change heating and/or cooling patterns in a datacenter over the course of a day. An operator may manually change the heating and/or cooling patterns. As computational load on servers in a datacenter changes, changes in heat generated by the servers may cause changes in the heating and cooling patterns in the datacenter. The control unit 104 may develop a set of tuned sensor settings that correspond to a determined heating and/or cooling condition. Subsequently, the control unit 104 may set the parameters of the sensors 102 to the settings that match the conditions of the area 114.

The control unit 104 may control the HVAC 116. The control unit 104 may systematically adjust heating and/or cooling conditions in the area 114, and tune the sensors 102 at each condition. For example, the control unit 104 may cause the temperature to vary over a range, and tune the sensors 102 at each temperature in the range. The control unit 104 may store the tuned value set for each condition. When any of the conditions is later encountered and/or detected, the control unit 104 may retrieve a corresponding tuned value set. The control unit 104 may set the parameters of the sensors 102 to the tuned value set that corresponds to the current condition of the area 114. The current condition of the area 114 may be determined by one or more temperature sensors, or other type of sensors. The temperature sensors or other type of sensors may be in communication with the control unit 104 and/or the sensor gateways 106.

For example, the output of the HVAC 116 may be lower at night in a datacenter than during the day. Accordingly, the control unit 104 may set a sensitivity parameter of the sensor 102 to a higher value at night than during the day. As a result, the sensors 102 may be more likely to detect a person at night, and the HVAC 116 is less likely to cause the sensors 102 to produce a false indication that the area 114 is occupied during the day. The control unit 104 may decrease the sensitivity of the sensors 102 when the HVAC 116 is blowing air, and increase the sensitivity of the sensors 102 when the HVAC 116 is not blowing air.

The control unit 104 may be a central control unit because it may centrally coordinate control of the tuning of the sensors 102 over the network 110. The central control unit may or may not be physically located in a central location. The control unit 104 may be considered remote to the sensors 102 because the control unit 104 communicates with the sensors 102 over the network 110.

Values of the parameters of the sensors 102 may be of any format. For example, the type of the values may be numeric, hexadecimal, integer, character, string, or any other data type.

The control unit 104 is described above as performing multiple tasks. However, the sensor 102 and/or the sensor gateway 106 may perform one or more of those tasks.

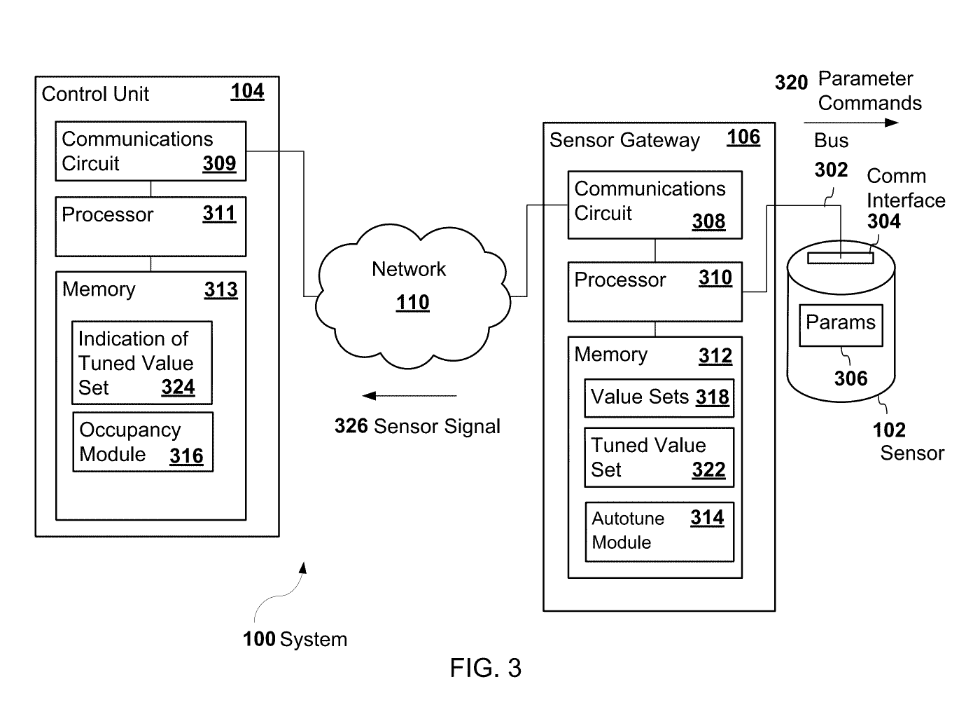

For example, FIG. 3 illustrates an example of the system 100 in which the sensor gateway 106 tunes the sensors 102 at the direction of the control unit 104. The system 100 may include the control unit 104, the sensor gateway 106, and the sensor 102. The system 100 may include additional sensors on the network 110.

The control unit 102 may be in communication with the sensor gateway 106 over the network 110. The sensor gateway 106 may be in communication with the sensor 102 over a bus 302 or any other type of communications link, such as a wireless link.

The bus 302 may be any type of bus or communications link. For example, the bus 302 may be an I²C (Inter-Integrated Circuit) BUS, which is a registered trademark of NXP B.V. CORPORATION NETHERLANDS Eindhoven Netherlands. In a different example, the bus 302 may be a USB (Universal Serial Bus).

The sensor 102 may include a communications interface 304 over which parameters 306 of the sensor 102 may be set. The communications interface 304 may be one or more pins on a chip, a USB connector, or any other hardware over which changes to the parameters 306 may be received.

The sensor gateway 106 may include a communications circuit 308, a processor 310, and a memory 312. The control unit 104 may include a communications circuit 309, a processor 311, and a memory 313.

The communications circuit 308 or 309 may be any hardware or a combination of hardware and software that enables communication over the network 110. The communications circuit 308 or 309 may provide physical access to the network 110 and provide a low-level addressing system through use of, for example, Media Access Control (MAC) addresses. The communications circuit 308 or 309 may comply with a proprietary standard, an open standard, or no standard at all. The communications circuit 308 or 309 may, in some examples, include a network interface controller or a network card that is installed inside a computer or other device. Alternatively or in addition, the communications circuit 308 or 309 may be a component of a circuit, a component of a computer mother board, an expansion card, a USB (universal serial bus) device, or as part of any other hardware.

The memory 312 or 313 may be any device for storing and retrieving data or any combination thereof. The memory 312 or 313 may include non-volatile and/or volatile memory, such as a random access memory (RAM), a read-only memory (ROM), an erasable programmable read-only memory (EPROM), or flash memory. Alternatively or in addition, the memory 312 or 313 may include an optical, magnetic (hard-drive) or any other form of data storage device.

The processor 310 or 311 may be any hardware that executes instructions. Examples of the processor 310 or 311 include a microcontroller, a general processor, a central processing unit (CPU), a graphics processing unit (GPU), a digital signal processor (DSP), an application specific integrated circuit (ASIC), a field programmable gate array (FPGA), a digital circuit, an analog circuit, any other type of processor, or any combination thereof. The processor 310 or 311 may include one or more components that execute computer executable instructions or computer code embodied in the memory 312 or 313 or in other memory.

In one example, the memory 312 of the sensor gateway 106 may include an autotune module 314 that is executable by the processor 310 of the sensor gateway 106. In a second example, the memory 313 of the control unit 104 may include an occupancy module 316 that is executable by the processor 311 of the control unit 104.

During operation of the system 100, the occupancy module 316 of the control unit 104 may determine that the area 114 monitored by the sensor 102 is unoccupied. The occupancy module 316 may transmit an indication to the sensor gateway 106 that the area 114 is unoccupied. The occupancy module 316 may direct the communications circuit 309 of the control unit 104 to transmit the indication over the network 110 to the sensor 102. In one example, the indication may simply be an instruction to start autotuning the sensor 102.

The autotune module 314 may receive the indication that the area 114 is unoccupied from the control unit 104 over the network 110 via the communications circuit 308 of the sensor gateway 106. The autotune module 314 may generate one or more value sets 318 using one or more of the mechanisms described above that the control unit 104 may use to the value sets 318. The autotune module 314 may generate the value sets 318 in the memory 312 of the sensor gateway 106. Alternatively or in addition, the control unit 104 may transmit the value sets 318 to the sensor gateway 106 for the autotune module 314 to iterate over.

The autotune module 314 may set the parameters 306 of the sensor 102 to each corresponding one of the value sets 318 by transmitting parameter commands 320 over the bus 302 to the communications interface 304 of the sensor 102. The parameter commands 320 may identify values that the parameters 306 of the sensors 102 are to be set to. For example, one of the parameter commands 320 may include a value from one of the values sets 318 that corresponds to one of the parameters 306. Alternatively or in addition, one of the parameter commands 320 may include the values that are in one of the value sets 318, where the values included in the parameter command correspond to the parameters 306 of the sensor 102.

The processor 310 of the sensor gateway 106 may process a signal received from the sensor 102 that indicates whether movement and/or occupancy is detected by the sensor 102. The sensor 102 may transmit the signal over the bus 302, or over some other channel, to the sensor gateway 106. The signal may be analog or digital. The parameter commands 320, together with the signal from the sensor 102, may form a closed feedback loop between the sensor gateway 106 and the sensor 102. The autotune module 314 may determine a tuned value set 322 using the closed feedback loop between the sensor gateway 106 and the sensor 102 instead of a closed feedback loop between the control unit 104 and the sensor 102.

The autotune module 314 of the sensor gateway 106 may transmit an indication of the tuned value set 324 to the control unit 104. The control unit 104 may store the indication of the tuned value set 324 in the memory 313 of the control unit 104. The indication of the tuned value set 324 may include the tuned value set 322. Alternatively or in addition, the indication of the tuned value set 324 may include a reference to the tuned value set 322. For example, the reference may be a unique identifier that the sensor gateway 106 uses to look up the tuned value set 322.

The control unit 104 may associate the indication of the tuned value set 324 with a condition of the area 114 monitored by the sensor 102. The control unit 104, when the condition is encountered later, may instruct the sensor gateway 106 to set the parameters 306 of the sensor 102 to the tuned value set 322 indicated by the indication of the tuned value set 324.

Alternatively, the control unit 104 may store the indication of the tuned value set 322 unassociated with the condition of the area 114. The control unit 104 may transmit the tuned value set 324 to the sensor gateway 106 when the sensor gateway 106 is replaced by a replacement sensor that has not been tuned.

The sensor gateway 106 may transmit a sensor signal 326 to the control unit 104. The sensor signal 326 may include a motion signal that indicates whether motion is detected by the sensor 102. Alternatively or in addition, the sensor signal 326 may include an occupancy signal that indicates whether the area 114 monitored by the sensor 102 is occupied. The sensor gateway 106 may or may not transmit the sensor signal 326 to the control unit 104 while the autotune module 314 of the sensor gateway 106 tunes the sensor 102.

The system 100 may be implemented in many different ways. For example, although some features are shown stored in computer-readable memories (e.g., as logic implemented as computer-executable instructions or as data structures in memory), all or part of the system and its logic and data structures may be stored on, distributed across, or read from other machine-readable storage media. The media may include memories, hard disks, floppy disks, CD-ROMs, or any other type storage medium.

As another example, although some features are shown stored in computer-readable memories, such features may be implemented in hardware, firmware, such as in a circuit. For example, the occupancy module 316 may be implemented as a digital circuit.

The system 100 may be implemented with additional, different, or fewer components than illustrated in FIGS. 1 and 3. For example, the system 100 may not include the light fixtures 108.

Each of the components of the system 100 may include additional, different, or fewer components than illustrated in FIGS. 1 and 3. For example, the memory 313 of the control unit 104 may include the autotune module 314 or some other module. As another example, the memory 312 of the sensor gateway 106 may include a detection component that converts a sensor element signal received from the sensor 102 into the sensor signal 326 that the sensor gateway 106 transmits to the control unit 104.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (e.g., a dynamic link library (DLL)).

The memories 312 and 313 may hold the programs and processes that implement the logic described above for execution by the processors 310 and/or 311. As examples, the memory 312 of the sensor gateway 106 may store program logic that implements the autotune module 314, or any other part of logic.

The processor 310 and/or 311 may be one or more devices operable to execute computer executable instructions or computer code embodied in the memory 312 and/or 313 or in other memory to perform the features of the system 100. The computer code may include instructions executable with the processor 310 and/or 311. The computer code may be written in any computer language, such as C++, C#, Java, Pascal, Visual Basic, Perl, HyperText Markup Language (HTML), JavaScript, assembly language, shell script, or any combination thereof. The computer code may include source code and/or compiled code.

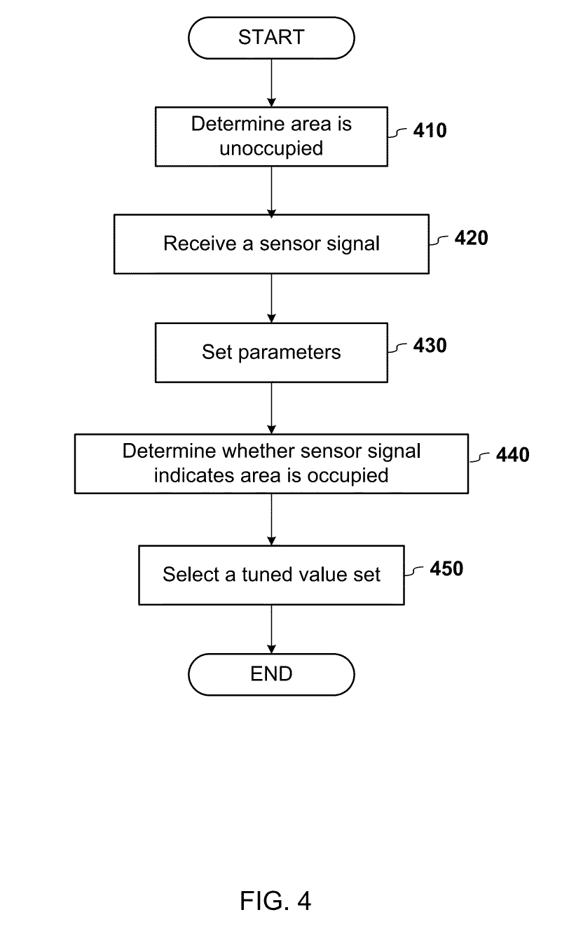

FIG. 4 illustrates an example flow diagram of the logic of the system 100. The logic may include additional, different, or fewer operations. The operations may be executed in a different order than illustrated in FIG. 4.

The logic may begin with an operation in which a determination is made (410) at the control unit 104 that the area 114 monitored by the sensor 102 is unoccupied. The sensor signal 326 may be received (420) at the control unit 104 from the sensor 102 over the network 110, where the sensor signal 326 indicates whether the sensor 102 detects an occupant in the area 114.

Multiple parameters 306 of the sensor 102 may be set (430) to multiple value sets 318 by transmitting the parameter commands 320 via the communications circuit 309 over the network 110 to the sensor 102, where each of the value sets 318 comprises a respective set of values for the parameters 306 of the sensor 102. A determination may be made (440) by the control unit 104, for each of the value sets 318, whether the sensor signal 326 indicates that the area 114 is occupied when the parameters 306 of the sensor 102 are set to the respective set of values and when the area 114 is determined by the control unit 104 to be unoccupied.

The tuned value set 322 may be selected (450) with the control unit 104 from the value sets 322 such that the sensor signal 326 indicates the area 114 is unoccupied when the parameters 306 of the sensor 102 are set to the tuned value set 322 and the area 114 is unoccupied according to the indication received from the control unit 104.

The logic may end with an operation, such as storing the tuned value set 322 in the memory of the control unit 104.

All of the discussion, regardless of the particular implementation described, is exemplary in nature, rather than limiting. For example, although selected aspects, features, or components of the implementations are depicted as being stored in memories, all or part of systems and methods consistent with the disclosure may be stored on, distributed across, or read from other computer-readable storage media, for example, secondary storage devices such as hard disks, floppy disks, and CD-ROMs; or other forms of ROM or RAM either currently known or later developed. The computer-readable storage media may be non-transitory computer-readable media, which includes CD-ROMs, volatile or non-volatile memory such as ROM and RAM, or any other suitable storage device. Moreover, the various modules and screen display functionality is but one example of such functionality and any other configurations encompassing similar functionality are possible.

Furthermore, although specific components were described, methods, systems, and articles of manufacture consistent with the disclosure may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program. The components may be resident on separate hardware, such as separate removable circuit boards, or share common hardware, such as a same memory and processor for implementing instructions from the memory. Programs may be parts of a single program, separate programs, or distributed across several memories and processors.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

While various embodiments have been described, it will be apparent to those of ordinary skill in the art that many more embodiments and implementations are possible within the scope of the disclosure. Accordingly, the innovation is not to be restricted except in light of the claims and their equivalents.

1. A control unit for limiting false detections of occupancy caused by air flow, the control unit comprising:
a communications circuit configured to communicate over a network with a plurality of motion sensors that detect motion in an area;
an occupancy module configured to determine that the area is unoccupied; and
an autotune module configured to determine, for at least one of the motion sensors on the network, a tuned value set from a plurality of value sets such that the at least one of the motion sensors transmits an indication over the network to the communications circuit that the area is unoccupied when parameters of the at least one of the motion sensors are set to the tuned value set, and the area is determined by the occupancy module to be unoccupied.

2. The control unit of claim 1, wherein the autotune module is further configured to transmit, for the at least one of the motion sensors, the tuned value set via the communications circuit over the network to the at least one of the motion sensors in a parameter command, and wherein the autotune module is configured to receive a sensor signal at the communications circuit from the at least one of the motion sensors over the network, the sensor signal indicative of whether the area is occupied.

3. The control unit of claim 1, wherein the autotune module is further configured to transmit an indication that the area is unoccupied over the network to the at least one of the motion sensors, and wherein the at least one of the motion sensors determines the tuned value set for the at least one of the motion sensors.

4. The control unit of claim 1, wherein the autotune module is further configured to associate the tuned value set for the at least one of the motion sensors on the network with a temperature of the area.

5. The control unit of claim 1, wherein the autotune module is further configured to direct an HVAC (Heating, Ventilation, and Air Conditioning) system to bring the area to a plurality of temperatures and to determine, for the at least one of the motion sensors, a corresponding tuned value set for the temperatures, wherein the at least one of the motion sensors indicates that the area is unoccupied when the area is determined by the occupancy module to be unoccupied, when the temperature of the area is at a respective one of the temperatures, and when the parameters of the at least one of the motion sensors are set to the corresponding tuned value set.

6. The control unit of claim 1, wherein the autotune module is further configured to determine the tuned value set for the at least one of the motion sensors on the network when the area is in a target condition, and to set the parameters of the at least one of the motion sensors to the tuned value set when the target condition is subsequently detected in the area.

7. The control unit of claim 1, wherein the occupancy module is further configured to determine that the area is unoccupied based on receipt of an indication by a user that the area is unoccupied.

8. A sensor gateway for limiting false detections of occupancy caused by air flow, the sensor gateway comprising:
a communications circuit configured to communicate over a network with a control unit;
a memory; and
a processor configured to receive data over the network from the control unit via the communications circuit, wherein the data indicates an area is unoccupied, wherein:
the processor is further configured to process a signal from a motion sensor positioned to detect movement in the area; and
the memory comprises an autotune module configured to:
iterate over a list of a plurality of values for a parameter of the motion sensor;
cause the processor to set the parameter of the motion sensor to a respective one of the values, and determine, for the respective one of the values, whether the signal from the motion sensor indicates the area is unoccupied; and
select a tuned value from the values such that the signal from the motion sensor indicates the area is unoccupied when the parameter of the motion sensor is set to the tuned value and the data from the control unit indicates the area is unoccupied.

9. The sensor gateway of claim 8, wherein the autotune module selects the tuned value from a determined range of values, and a respective value in the determined range of values caused the motion sensor to indicate that the area is unoccupied.

10. The sensor gateway of claim 9, wherein the autotune module selects the tuned value as a value in the determined range of values that is a predetermined distance away from a transition value in the determined range of values, wherein the transition value is a first or last value in the determined range of values and is a next value in the list of values after a second value in the list of values that caused the motion sensor to indicate the area is occupied.

11. The sensor gateway of claim 9, wherein the autotune module selects the tuned value as a value in the middle of the determined range of values.

12. The sensor gateway of claim 9, wherein the autotune module selects the tuned value from the determined range of values based on knowledge of an effective range for the parameter.

13. A method to limit false detections of occupancy caused by air flow, the method comprising:
determining at a control unit that an area monitored by a motion sensor is unoccupied, the control unit comprising a communications circuit that communicates with the motion sensor over a network;
receiving a sensor signal at the control unit from the motion sensor over the network, the sensor signal indicating whether the motion sensor detects that the area is occupied;
setting a parameter of the motion sensor to a plurality of value sets by transmitting parameter commands with the communications circuit over the network to the motion sensor, wherein a respective one of the value sets comprises a respective value for the parameter of the motion sensor;
determining with the control unit, for the respective one of the value sets, whether the sensor signal indicates that the area is occupied when the parameter of the motion sensor is set to the respective value and when the area is determined by the control unit to be unoccupied; and
selecting a tuned value set with the control unit from the value sets such that the sensor signal indicates the area is unoccupied when the parameter of the motion sensor is set to a tuned value in the tuned value set and the area is determined to be unoccupied by the control unit.

14. The method of claim 13 further comprising verifying that the sensor signal indicates the area is occupied when the parameter of the motion sensor is set to the tuned value in the tuned value set and a motorized mobile device is operated in the area.

15. The method of claim 13 further comprising determining with the control unit, for a respective one of the value sets, whether the sensor signal indicates that the area is occupied when a plurality of parameters of the motion sensor are set to values in a respective value set and when the area is determined by the control unit to be unoccupied.

16. The method of claim 15 further comprising selecting the tuned value set with the control unit from the value sets such that the sensor signal indicates the area is unoccupied when the parameters of the motion sensor are set to the values in the tuned value set and the area is unoccupied according to the indication received from the control unit.

17. The method of claim 13, wherein selecting the tuned value set comprises selecting the first of the value sets determined to cause the sensor signal to indicate the area is unoccupied when the parameter of the motion sensor is set to a tuned value in the tuned value set and the area is unoccupied according to the indication received from the control unit.

18. The method of claim 17, wherein the value sets are in an order and the order of the value sets is based on knowledge of operation of the sensors.
